(19) United States
(12) Patent Application Publication
(10) Pub. No.: US 2016/0195776 A1
(43) Pub. Date: Jul. 7, 2016

(54) LIQUID CRYSTAL DISPLAY DEVICE

(71) Applicant: SAMSUNG DISPLAY CO., LTD., Yongin-si (KR)

(72) Inventors: Gak Seok LEE, Hwaseong-si (KR); Seung Yeon JEONG, Hwaseong-si (KR); Hyo Ju JUNG, Namdong-gu (KR)

(21) Appl. No.: 14/925,888

(22) Filed: Oct. 28, 2015

(30) Foreign Application Priority Data
Jan. 7, 2015 (KR) 10-2015-0001984

(51) Int. Cl. G02F 1/1337; G02F 1/1343

(52) U.S. Cl. CPC G02F 1/133707; G02F 1/13439; G02F 1/134309; G02F 2001/134345

(57) ABSTRACT

A liquid crystal display device includes a first substrate, a pixel electrode formed on the first substrate, a second substrate facing the first substrate, a common electrode formed on the second substrate, and a liquid crystal layer disposed between the first substrate and the second substrate. The pixel electrode includes a first subpixel electrode and a second subpixel electrode disposed in a pixel area and spaced apart from each other, and the second subpixel electrode is disposed at four corners of the pixel area. A first voltage is applied to the first subpixel electrode and a second voltage is applied to the second subpixel electrode, and the first voltage is different from the second voltage.

### CROSS-REFERENCE TO RELATED APPLICATION

This application claims priority to and the benefit of Korean Patent Application No. 10-2015-0001984 filed in the Korean Intellectual Property Office on Jan. 7, 2015, the entire contents of which are incorporated herein by reference.

### BACKGROUND

(a) Technical Field

The present disclosure generally relates to a liquid crystal display device.

(b) Description of the Related Art

Liquid crystal display devices are currently widely used in flat panel displays. A liquid crystal display device typically includes two sheets of display panels on which field generating electrodes (such as a pixel electrode and a common electrode) are formed and a liquid crystal layer interposed therebetween. An electric field is generated by applying a voltage to the field generating electrode. The electric field determines an orientation of the liquid crystal molecules in the liquid crystal layer and controls polarization of incident light passing through the liquid crystal layer, thereby displaying an image on the liquid crystal display device.

Liquid crystal display devices may be provided in different configurations. For example, in a vertically aligned mode liquid crystal display device, the major axes of the liquid crystal molecules are aligned perpendicular to the upper and lower display panels when an electric field is not applied to the liquid crystal layer. The vertically aligned mode liquid crystal display device is widely used because it has a high contrast ratio and a wide reference viewing angle.

To achieve a wide reference viewing angle in a vertically aligned mode liquid crystal display device, a method for forming cut parts such as fine slits in a field generating electrode and protrusions is used. The cut parts and protrusions determine a tilt direction in which liquid crystal molecules is tilted. Accordingly, the cut parts and protrusions are appropriately disposed to disperse the tilt direction of the liquid crystal molecules into several directions so as to expand the reference viewing angle.

In recent years, a curved display panel has been developed to meet the demand for a large-screen liquid crystal display device and to increase a viewer's immersion experience. An edge of the display panel is often fixed by a sealant. In some instances, when the display panel is bent to form the curved display panel, buckling may occur at a middle portion of the panel, which may lead to alignment mismatch between two display plates of the display panel. The alignment mismatch may cause the directions of pretilts (the pretilts are formed on the two display plates in a plurality of same directions) to partially deviate from each other to form dark parts (such as texture in a pixel), thereby reducing display quality.

The above information disclosed in this Background section is to enhance understanding of the background of the inventive concept and therefore it may contain information that does not form the prior art that is already known in this country to a person of ordinary skill in the art.

### SUMMARY

The present disclosure addresses at least the above issues in the prior art.

According to an exemplary embodiment of the inventive concept, a liquid crystal display device is provided. The liquid crystal display device includes: a first substrate; a pixel electrode formed on the first substrate, wherein the pixel electrode includes a first subpixel electrode and a second subpixel electrode disposed in a pixel area and spaced apart from each other, and wherein the second subpixel electrode is disposed at four corners of the pixel area; a second substrate facing the first substrate; a common electrode formed on the second substrate; and a liquid crystal layer disposed between the first substrate and the second substrate, wherein a first voltage is applied to the first subpixel electrode and a second voltage is applied to the second subpixel electrode, and wherein the first voltage is different from the second voltage.

In some embodiments, the liquid crystal display device may be a curved type liquid crystal display.

In some embodiments, the first voltage may be less than the second voltage.

In some embodiments, the first subpixel electrode may include a plurality of first branch electrodes and the second subpixel electrode may include a plurality of second branch electrodes.

In some embodiments, the first subpixel electrode may have a dodecagonal polygon shape, and the second subpixel electrode may have a shape including a cluster of four quadrangles.

In some embodiments, the first subpixel electrode may further comprise a cruciform stem part including a horizontal stem part and a vertical stem part, and the plurality of first branch electrodes may extend in four different directions from the cruciform stem. The second subpixel electrode may further comprise an outer stem part disposed outside the pixel area, and the plurality of second branch electrodes may extend in four different directions toward the first subpixel electrode of the pixel area

In some embodiments, the first subpixel electrode may have a rhombus shape, and the second subpixel electrode may have a shape including a cluster of four triangles.

In some embodiments, the first subpixel electrode may further comprise a cruciform stem part including a horizontal stem part and a vertical stem part, and the plurality of first branch electrodes may extend in four different directions from the cruciform stem. The second subpixel electrode may further comprise an outer stem part disposed outside the pixel area, and the plurality of second branch electrodes may extend in four different directions from the outer stem part toward the first subpixel electrode.

Some or all of the above embodiments of the liquid crystal display device may reduce display defects (such as texture or spots which may occur due to misalignment between the upper and lower plates), and allow reduction in transmittance to be controlled.

### BRIEF DESCRIPTION OF THE DRAWINGS

FIG. 1 is a layout view of a liquid crystal display device according to an exemplary embodiment.

FIG. 2 is a cross-sectional view of the liquid crystal display device of FIG. 1 taken along line II-II.

FIG. 3 is an equivalent circuit diagram of a pixel according to an exemplary embodiment.

FIG. 4 illustrates a method of forming a pretilt in the liquid crystal molecules using a light-polymerized prepolymer.

FIG. 5 is a graph of the applied voltage as a function of time during electric field UV exposure according to an exemplary embodiment.

FIGS. 6, 7, 8, and 9 illustrate pixel images according to a slope of the liquid crystal molecules for a pixel electrode to which different voltages are applied.

FIG. 10 is a layout view of a liquid crystal display device according to another exemplary embodiment.

### DETAILED DESCRIPTION

The inventive concept will be described more fully herein with reference to the accompanying drawings, in which exemplary embodiments are shown. As those skilled in the art would realize, the embodiments may be modified in various ways without departing from the spirit or scope of the present disclosure.

In the drawings, the thickness of layers, films, panels, regions, etc., may be exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

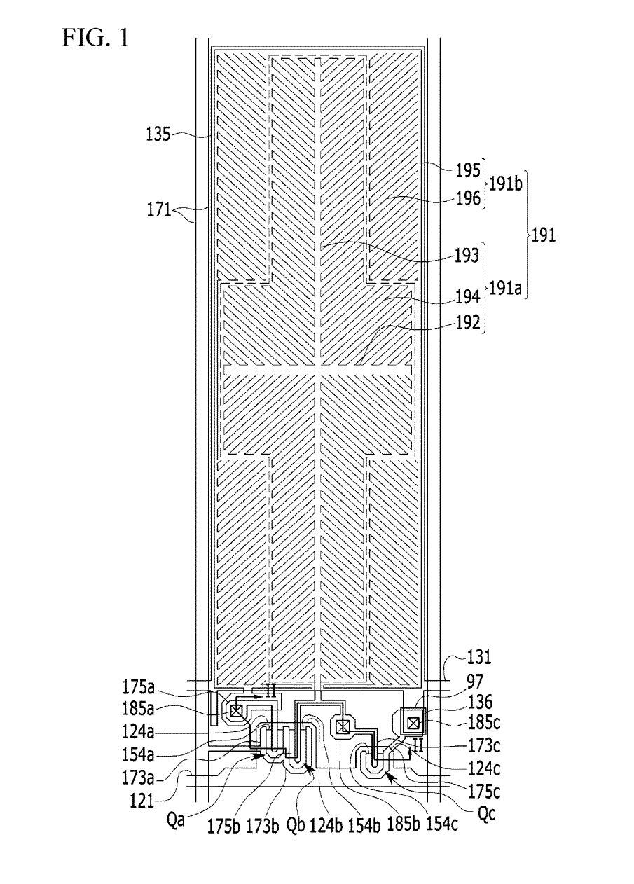

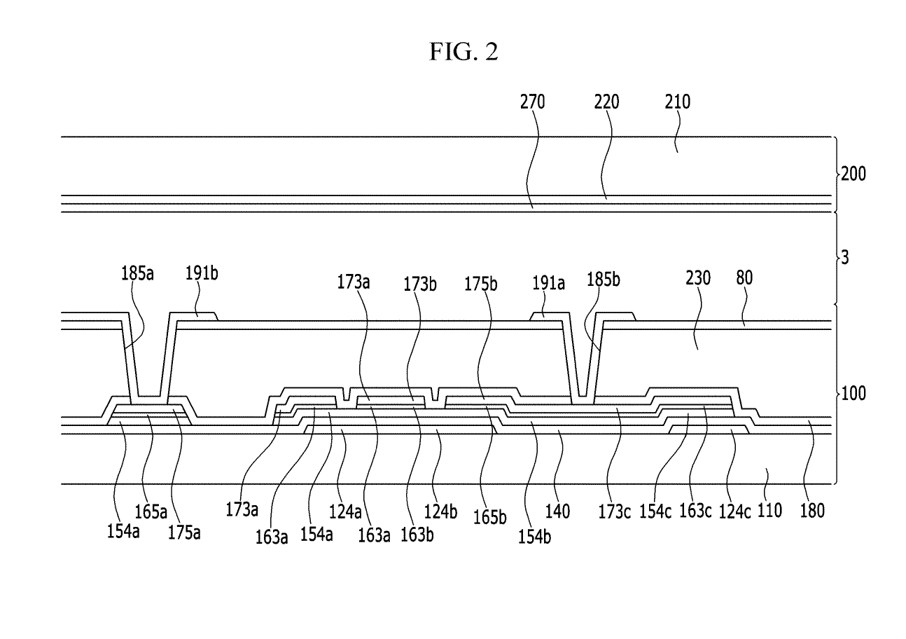

First, a liquid crystal display device according to an exemplary embodiment will be described in detail with reference to FIGS. 1 and 2. Specifically, FIG. 1 is a layout view of the exemplary liquid crystal display device and FIG. 2 is a cross-sectional view of the exemplary liquid crystal display device taken along line II-II in FIG. 1.

Although the embodiments are described with reference to a curved liquid crystal display device, the inventive concept is not limited thereto and may also be applied to a flat panel display. Referring to FIG. 1, the exemplary liquid crystal display device is a curved liquid crystal display device. For example, the exemplary liquid crystal display device may be curved in a horizontal direction in a major axis or curved in a vertical direction in a minor axis.

Referring to FIGS. 1 and 2, the liquid crystal display device includes a lower panel 100 and an upper panel 200 facing each other and a liquid crystal layer 3 interposed between the two display panels 100 and 200.

First, the structure of the lower display panel 100 will be described. The lower display panel 100 includes a plurality of gate conductors disposed on a first substrate 110. The gate conductors include gate lines 121, reference voltage lines 131, and storage electrode lines 135. The gate line 121 and a step-down gate line transfer gate signals and extend in a substantially horizontal direction.

The gate line 121 includes a wide end (not illustrated) connected with a first gate electrode 124a, a second gate electrode 124b, a third gate electrode 124c, and other layers or external driving circuits. The first and second gate electrodes 124a and 124b are connected to each other.

The reference voltage line 131 may extend parallel to the gate line 121. The reference voltage line 131 includes a sustain extension 136 connected to a third drain electrode 175c, as described in further detail below.

The reference voltage line 131 includes the storage electrode line 135 enclosing a pixel area. The storage electrode line 135 may extend in a substantially vertical direction to the sustain extension 136 and the gate line. However, it should be noted that the structure of the storage electrode line 135 is not limited thereto and may be modified in different ways.

A gate insulating layer 140 is formed on the gate line 121, the reference voltage line 131, and the storage electrode line 135.

A first semiconductor 154a, a second semiconductor 154b, and a third semiconductor 154c are formed on the gate insulating layer 140. The first/second/third semiconductors 154a/154b/154c may be made of amorphous or crystalline silicon or any other suitable materials.

A plurality of ohmic contacts 163a, 163b, 163c, 165a and 165b are formed on the first semiconductor 154a, second semiconductor 154b, and third semiconductor 154c. In some alternative embodiments, when the semiconductors 154a, 154b, and 154c are oxide semiconductors, the ohmic contacts 163a, 165a, 163b, 165b and 163c may be omitted.

Data conductors are formed on the ohmic contacts 163a, 163b, 163c, 165a, 165b and the gate insulating layer 140. The data conductors include data lines 171, a first drain electrode 175a, a second drain electrode 175b, a third source electrode 173c, and a third drain electrode 175c. The data lines 171 include a first source electrode 173a and a second source electrode 173b.

A bar-shaped end of the first and second drain electrodes 175a and 175b is partially enclosed with the first and second source electrodes 173a and 173b. A wide end of the second drain electrode 175b may extend and connect to the third source electrode 173c such that the second drain electrode 175b is bent in the shape of a letter ‘U’. A wide end of the third drain electrode 175c overlaps the sustain extension 136 to form a step-down capacitor, and a bar-shaped end of the third drain electrode 175c is partially enclosed with the third source electrode 173c.

The first gate electrode 124a, first source electrode 173a, and first drain electrode 175a, together with the first semiconductor 154a, collectively constitute a first thin film transistor Qa. A channel of the first thin film transistor Qa is formed at the semiconductor part 154a between the first source electrode 173a and the first drain electrode 175a. Similarly, the second gate electrode 124b, second source electrode 173b, and second drain electrode 175b, together with the second semiconductor 154b, collectively constitute a second thin film transistor Qb. A channel of the second thin film transistor Qb is formed at the semiconductor part 154b between the second source electrode 173b and the second drain electrode 175b. Likewise, the third gate electrode 124c, third source electrode 173c, and third drain electrode 175c, together with the third semiconductor 154c, collectively constitute a third thin film transistor Qc. A channel of the third thin film transistor Qc is formed at the semiconductor part 154c between the third source electrode 173c and the third drain electrode 175c.

A passivation layer 180 is formed on the data conductors 171, 173a, 173b, 173c, 175a, 175b, and 175c and the exposed semiconductor parts 154a, 154b, and 154c. The passivation layer 180 may be made of inorganic insulating materials such as silicon nitride and silicon oxide.

A color filter 230 is disposed on the passivation layer 180.

A light blocking member 220 may be disposed over the color filter 230. The light blocking member 220 is referred to as a black matrix and prevents light leakage.

A capping layer 80 is disposed on the color filter 230. The capping layer 80 prevents the color filter 230 from lifting off and protects the liquid crystal layer 3 from contamination due to organic materials (such as a solvent introduced by the color filter 230). Accordingly, the capping layer 80 can reduce defects such as afterimages which may occur when a screen is being driven.

A pixel electrode 191 including a first subpixel electrode 191a and a second subpixel electrode 191b that are separated from the first subpixel electrode 191a and separated from a connection member 97 are disposed on the capping layer 80.

The pixel electrode 191 may be made of transparent conductive materials (such as ITO and IZO) or reflective metals (such as aluminum, silver, chromium, or an alloy thereof).

The pixel electrode 191 including the first subpixel electrode 191a and the second subpixel electrode 191b may be shaped as a quadrangle. The pixel electrode 191 further includes a connection part (dotted line in FIG. 1) formed between the first subpixel electrode 191a and the second subpixel electrode 191b. The connection part can improve the control efficiency and transmittance of the liquid crystal.

FIG. 1 also illustrates the pixel electrode according to an exemplary embodiment. Referring to FIG. 1, the first subpixel electrode 191a includes a plurality of fine branch parts extending from cruciform stem parts 192 and 193 toward an outside of the pixel area, such that the first subpixel electrode 191a has a cruciform shape. The second subpixel electrode 191b has a structure in which four quadrangles are disposed at the respective four corners of the pixel electrode 191.

Referring to FIG. 1, each of the first subpixel electrode 191a and the second subpixel electrode 191b may be divided into four domain regions. The domain region refers to an area comprising liquid molecules having inclined directors. Specifically, the liquid molecules are clustered in a specific direction by an electric field formed between the pixel electrode 191 and a common electrode. Boundaries between the four domains may be bent depending on the shape/configuration of the first subpixel electrode 191a and the second pixel electrode 191b.

The first subpixel electrode 191a includes the cruciform stem parts 192 and 193 dividing the pixel area into four domain regions. The cruciform stem parts 192 and 193 include the horizontal stem part 192 and the vertical stem part 193. To improve visibility, a width of the horizontal stem part 192 may be greater than a width of the vertical stem part 193. However, the inventive concept is not limited thereto. In some other embodiments, a width of the horizontal stem part 192 may be less than a width of the vertical stem part 193.

The first subpixel electrode 191a further includes a plurality of first branch electrodes 194 extending from the cruciform stem parts 192 and 193 and arranged in a constant direction within each domain. An interval between the plurality of first branch electrodes 194 may be constant.

The first branch electrodes 194 extend in four different directions. Specifically, the first branch electrodes 194 include a plurality of first fine branch parts extending obliquely in an upward left direction from the cruciform stem parts 192 and 193, a plurality of second fine branch parts extending obliquely in an upward right direction from the cruciform stem parts 192 and 193, a plurality of third fine branch parts extending obliquely in a downward left direction from the cruciform stem parts 192 and 193, and a plurality of fourth fine branch parts extending obliquely in a downward right direction from the cruciform stem parts 192 and 193. The first fine branch parts may form an angle of about 45° to the fourth fine branch parts and the horizontal stem part 192.

The second subpixel electrode 191b is divided into four domain regions by the first subpixel electrode 191a. Specifically, the second subpixel electrode 191b is disposed at four corners of the pixel electrode 191. The second subpixel electrode 191b may include an outer stem part 195 enclosing edges of the pixel area and a plurality of second branch electrodes 196 extending from the outer stem part 195. An interval between the plurality of second branch electrodes 196 may be constant.

According to another exemplary embodiment, the second subpixel electrode 191b may include a first connection part positioned at an edge of the pixel electrode 191 and adjacent to the first subpixel electrode 191a, and a plurality of second branch electrodes 196 extending from the first connection part.

The second branch electrodes 196 are arranged in a constant direction within each domain and extend in four different directions. Specifically, the second branch electrodes 196 include a plurality of fifth fine branch parts extending obliquely in an upward left direction from the cruciform stem parts 192 and 193, a plurality of sixth fine branch parts extending obliquely in an upward right direction from the cruciform stem parts 192 and 193, a plurality of seventh fine branch parts extending obliquely in a downward left direction from the cruciform stem parts 192 and 193, and a plurality of eighth fine branch parts extending obliquely in a downward right direction from the cruciform stem parts 192 and 193. The fifth fine branch parts may form an angle of about 45° to the eighth fine branch parts and the horizontal stem part 192.

The first fine branch parts, second fine branch parts, third fine branch parts, and fourth fine branch parts formed in each domain of the first subpixel electrodes 191a extend in the same direction as the respective fifth fine branch parts, sixth fine branch parts, seventh fine branch parts, and eighth fine branch parts formed in each domain of the second subpixel electrode 191b. Therefore, the liquid crystal molecules that are inclined in the same direction are formed within the domain region including the fine branch parts that extend in the same direction.

Further, the horizontal stem part 192 or the vertical stem part 193 of the first subpixel electrode 191a may be disposed between the second branch electrodes 196 of the second subpixel electrode 191b. That is, the second subpixel electrodes 191b are spaced apart from each other by the first subpixel electrode 191a, but the second branch electrodes 196 of the second subpixel electrode 191b may be adjacent to each other by extending from the horizontal stem part 192 or the vertical stem part 193. In the above embodiment, an electric field is generated between a portion of the horizontal stem part 192 or the vertical stem part 193 of the first subpixel electrodes 191a that are adjacent to each other and the second branch electrodes 196 of the second subpixel electrode 191b. Therefore, the liquid crystal molecules that are disposed around the horizontal stem part 192 or the vertical stem part 193 of the first subpixel electrode 191a will be inclined in a direction substantially parallel to a direction in which the second branch electrodes 196 of the second subpixel electrode 191b extend. As a result, deterioration of transmittance, which may occur around a portion of the horizontal stem part 192 or the vertical stem part 193 of the first subpixel electrode, can be prevented.

A first contact hole 185a and a second contact hole 185b are formed on the passivation layer 180 and the capping layer 80. The first contact hole 185a exposes a portion of the first drain electrode 175a, and the second contact hole 185b exposes a portion of the second drain electrode 175b.

The connection member 97 is disposed on the third drain electrode 175c and a portion of the sustain extension 136 exposed through the third contact hole 185c to connect the third drain electrode 175c and the sustain extension 136 to each other.

The first subpixel electrode 191a is physically and electrically connected to the second drain electrode 175b through the second contact hole 185b, and the second subpixel electrode 191b is physically and electrically connected to the first drain electrode 175a through the first contact hole 185a. An electric field is generated by applying the data voltage to the first subpixel electrode 191a and the second subpixel electrode 191b, along with a common electrode 270. The electric field determines an orientation of liquid crystal molecules of the liquid crystal layer 3 between the subpixel electrodes and the common electrode. The luminance of light passing through the liquid crystal layer 3 changes according to the orientation of the liquid crystal molecules.

Data voltages from the second drain electrode 175b and the first drain electrode 175a are applied to the first subpixel electrode 191a and the second subpixel electrode 191b, respectively, through the second contact hole 185b and the first contact hole 185a. In the above embodiment, a portion of the data voltage that is applied from the second drain electrode 175b is divided by the third source electrode 173c, such that a magnitude of the voltage applied to the first subpixel electrode 191a is smaller than a magnitude of the voltage applied to the second subpixel electrode 191b.

The liquid crystal layer 3 has a negative dielectric anisotropy. Accordingly, the liquid crystal molecules in the liquid crystal layer 3 are aligned such that the major axes thereof are perpendicular to the surfaces of the two display panels 100 and 200 in the absence of an electric field. Therefore, when an electric field is absent, incident light does not pass through the crossed polarizers but is instead blocked.

At least one of the liquid crystal layer 3 and an alignment layer may include a photoreactive material, for example, reactive mesogen.

Next, the structure of the upper panel 200 will be described.

The upper panel 200 includes the light blocking member 220 and the common electrode 270 formed on a second substrate 210. The second substrate 210 may be made of transparent glass, plastic, or the like.

It is noted that the structure of the liquid crystal display device is not limited to the configuration shown in FIG. 2. For example, in some other embodiments, the light blocking member 220 may be disposed on the lower display panel 100 and the color filter 230 may be disposed on the upper display panel 200.

The inner sides of the display panels 100 and 200 are provided with alignment layers (not illustrated). The alignment layers may be a vertical alignment layer.

A polarizer (not illustrated) is disposed on the outer surfaces of the two display panels 100 and 200. The transmission axes of the two polarizers are orthogonal to each other, and one of the transmission axes is preferably parallel with the gate line 121. In some alternative embodiments, the polarizer may be disposed on the outer surface of only one of the two display panels 100 and 200.

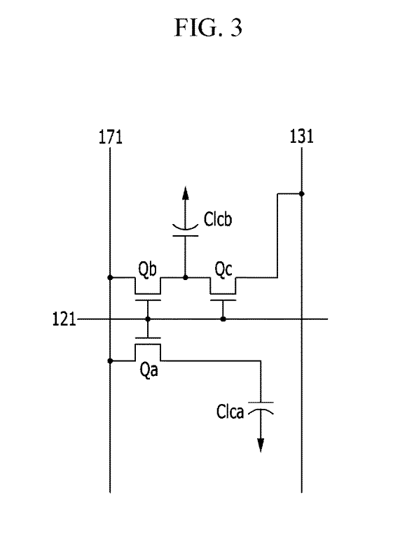

Next, a method for driving a liquid crystal display device according to an exemplary embodiment will be described with reference to FIGS. 1 and 3. FIG. 3 is an equivalent circuit diagram of a pixel of the liquid crystal display device according to an exemplary embodiment.

When a gate on signal is applied to the gate line 121, a gate on signal is applied to the first gate electrode 124a, second gate electrode 124b, and third gate electrode 124c, thereby turning on a first switching element Qa, second switching element Qb, and third switch element Qc. The data voltage that is applied to the data line 171 is applied to the second subpixel electrode 191b and the first subpixel electrode 191a, respectively, through the first and second switching elements Qa and Qb that are turned on. In the above embodiment, voltages of a same magnitude are applied to the first subpixel electrode 191a and the second subpixel electrode 191b. However, the voltage that is applied to the first subpixel electrode 191a is divided through the third switching element Qc which is connected to the second switching element Qb in series. Therefore, the voltage applied to the first subpixel electrode 191a is smaller than the voltage applied to the second subpixel electrode 191b.

Since the voltage charged in the first liquid crystal capacitor Clca and the voltage charged in the second liquid crystal capacitor Clcb are different from each other, the angles of inclination of the liquid crystal molecules in the first subpixel and the second subpixel are different from each other, and thus the luminance of the two subpixels are different from each other. By controlling the voltage of the first liquid crystal capacitor Clca and the voltage of the second liquid crystal capacitor Clcb in the above manner, an image that is viewed from the side would be similar to an image that is viewed from the front, thereby improving side visibility.

The second liquid crystal capacitor Clcb is connected to the first subpixel electrode 191a and the first liquid crystal capacitor Clca is connected to the second subpixel electrode 191b. To make a voltage charged in the second liquid crystal capacitor Clcb different from a voltage charged in the first liquid crystal capacitor Clca, the exemplary liquid crystal display device includes an output terminal of the second switching element Qb connected to the first subpixel electrode 191a forming the second liquid crystal capacitor Clcb, and an output terminal of the third switching element Qc connected to a voltage dividing reference voltage line 131. However, the inventive concept is not limited thereto. For example, in some other embodiments, the second liquid crystal capacitor Clcb may include the third switching element Qc connected to a step-down capacitor.

According to another exemplary embodiment, the liquid crystal display device may include an output terminal of the first switching element Qa connected to the first subpixel electrode 191a forming the first liquid crystal capacitor Clca, and an output terminal of the third switching element Qc connected to the step-down capacitor. The third switching element Qc may be connected to the step-down gate line different from those of the first switching element Qa and the second switching element Qb, and a gate on signal may be applied to the gate line to turn on the first switching element Qa and the second switching element Qb and then turn them off. The gate on signal may then be applied to the step-down gate line to turn on the third switching element Qc. When the first switching element Qa and the second switching element Qb are turned on and then off and the third switching element Qc is then turned on, charges move from the first subpixel electrode 191a through the third switching element Qc. Subsequently, the charging voltage of the first liquid crystal capacitor Clca is reduced and the step-down capacitor is charged. The charging voltage of the first liquid crystal capacitor Clca is reduced by as much as the capacitance of the step-down capacitor, and therefore the charging voltage of the first liquid crystal capacitor Clca is reduced further compared to that of the second liquid crystal capacitor Clcb. In the above embodiment, a difference in the charging voltage may be controlled according to the magnitude in voltage applied to a second reference voltage line connected to the other terminal of the step-down capacitor.

It is noted that the charging voltage between the first and second liquid crystal capacitors Clca and Clcb may be set differently using methods other than those described above, in order to improve the side visibility of the liquid crystal display device.

In a conventional liquid crystal display device, each of a first subpixel electrode and a second subpixel electrode may be formed having substantially a quadrangle shape. The first subpixel electrode and the second subpixel electrode may be disposed over and under the pixel area, and spaced apart from each other. Further, each of the first subpixel electrode and the second subpixel electrode may include the cruciform stem part and the plurality of branch electrodes extending from the cruciform stem part. In particular, the transmittance of the conventional liquid crystal display device may deteriorate in a region between the first subpixel electrode and the second subpixel electrode and in a region of the cruciform stem parts of the respective first subpixel electrode and the second subpixel electrode.

When the display panel in the conventional liquid crystal display device is bent to form the curved display panel, an alignment mismatch between the lower display panel and the upper display panel occurs, which creates a region in which pretilt directions of the upper and lower display panels are mismatched with each other. The directions of inclination of the liquid crystal molecules in the region are mismatched, and as a result a texture appears on the screen.

However, in the exemplary liquid crystal display device, the first subpixel electrode 191a and the second subpixel electrode 191b are formed on the same substrate. The first subpixel electrode 191a has a polygon shape such as a quadrangle or a dodecagon. Specifically, the first subpixel electrode 191a is disposed at a middle of the pixel electrode to form four domains, the second subpixel electrode 191b has a triangle or a quadrangle shape, and the second subpixel electrode 191b is disposed at the edge of the pixel area. Further, the first subpixel electrode 191a includes the cruciform stem parts 192 and 193 and the plurality of first branch electrodes 194 extending from the cruciform stem parts 192 and 193. The cruciform stem parts 192 and 193 include the horizontal stem part 192 and the vertical stem part 193. The second subpixel electrode 191b may include the outer stem part 195 formed along an outside portion of the pixel area and the plurality of second branch electrodes 196 extending from the outer stem part 195. Therefore, an interval spacing between the first subpixel electrode 191a and the second subpixel electrode 191b may be relatively narrow, the stem part of the second subpixel electrode 191b is not formed at the central portion of the pixel area, and the second subpixel electrode 191b includes the outer stem part formed along the outside portion of the pixel area. In particular, the above structure can prevent the transmittance occurring around the cruciform stem part from deteriorating.

Furthermore, when the pixel electrode 191 according to the exemplary embodiment is implemented in the curved display panel, the first subpixel electrode 191a, to which a relatively lower voltage is applied, is disposed at the central portion of the pixel electrode 191. Therefore, a small pretilt is formed at the central portion of the pixel electrode 191. Thus, even though some misalignment may occur when forming the curved panel, the texture or spot (seen in the conventional pixel structure) does not occur.

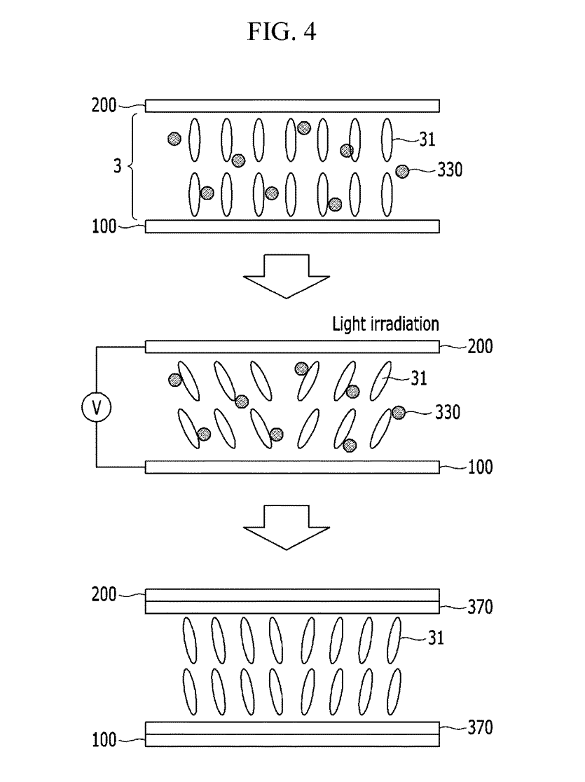

As described above, at least one of the liquid crystal layer 3 and the alignment layer may include a photoreactive material. Next, a method for orienting the liquid crystal molecules 31 using the photoreactive material so that the liquid crystal molecules 31 have the pretilt will be described with reference to FIG. 4. Specifically, FIG. 4 illustrates a process of forming a pretilt in the liquid crystal molecules using a prepolymer. The prepolymer is polymerized by light such as ultraviolet rays.

First, a prepolymer 330 is injected between the two display panels 100 and 200, along with the liquid crystal molecules 31. The prepolymer 330 may be a monomer that is cured by polymerization due to light. For example, the prepolymer 330 may be a reactive mesogen which performs the polymerization by light. The light may include ultraviolet rays.

Next, a voltage having different magnitudes is applied to the first subpixel electrode 191a and the second subpixel electrode 191b, and a common voltage is applied to the common electrode 270 of the upper panel 200, so as to generate an electric field in the liquid crystal layer 3 between the two display panels 100 and 200. The liquid crystal molecules 31 of the liquid crystal layer 3 respond to the electric field by inclining in four respective directions, for example, in a direction parallel with a direction in which the first branch electrodes 194 of the first subpixel electrode 191a extend by a fringe field by the plurality of first branch electrodes 194 of the first subpixel electrode 191a and the common electrode 270. Furthermore, the liquid crystal molecules 31 are also inclined in four respective directions, for example, in a direction parallel with a direction in which the second branch electrodes 196 of the second subpixel electrode 191b extend by a fringe field by the plurality of second branch electrodes 196 of the second subpixel electrode 191b and the common electrode 270. In the above embodiment, since a voltage having different magnitudes is applied to the first subpixel electrode 191a and the second subpixel electrode 191b, an angle of inclination of the liquid crystal molecules 31 corresponding to the first subpixel electrode 191a and an angle of inclination of the liquid crystal molecules 31 corresponding to the second subpixel electrode 191b are different from each other. The angles of inclination are measured with respect to the first substrate 110.

When the electric field is generated in the liquid crystal layer 3 and light, such as ultraviolet rays, is irradiated onto the prepolymer 330, the prepolymer 330 then undergoes polymerization to form a polymer 370. The polymer 370 is formed in contact with the display panels 100 and 200. The alignment direction of the liquid crystal molecules 31 is defined by the polymer 370 to have the pretilt in the directions described above. Therefore, the liquid crystal molecules 31 are aligned having the pretilt in four different directions even when a voltage is not applied to the field generating electrodes 191 and 270.

In the case of a conventional curved liquid crystal display device, misalignment between the upper and lower substrates occurs at the left and right sides of the panel due to a tensile force resulting from a warpage of the substrate. In a vertical alignment (VA) mode in which the pretilt is already formed during the electric field exposure process, the pretilt of the adjacent domains moves due to the misalignment and thus a dark spot in a texture form occurs, thereby reducing the transmittance. The above phenomenon results from the different pretilt directions of the upper and lower panels in the conventional curved liquid crystal display device. Since the pretilt is increased, the transmittance is further reduced due to the dark spot.

However, in the case of the exemplary curved liquid crystal display device, the first subpixel electrode 191a and the second subpixel electrode 191b are formed on the same substrate and different voltages are applied thereto, which can mitigate the above problem seen in the conventional curved liquid crystal display device. In particular, a relatively lower voltage is applied to the pixel electrode of the central portion of the panel to reduce the pretilt, which can prevent texture due to misalignment from occurring.

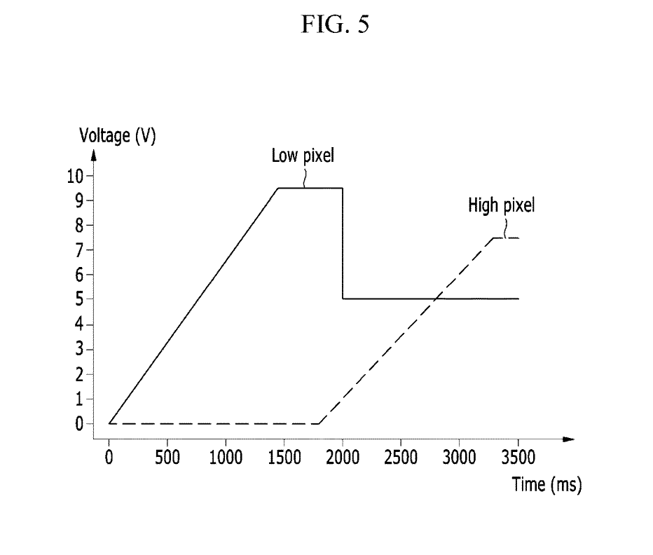

Next, the voltage applied to the first subpixel electrode 191a and the second subpixel electrode 191b in an exemplary embodiment will be described with reference to FIG. 5. Specifically, FIG. 5 is a graph of the applied voltage as a function of time during the electric field UV exposure.

As shown in FIG. 5, a low voltage is first applied to the first subpixel electrode positioned at the center of the pixel electrode during the electric field UV exposure process, and then a high voltage is applied to the second subpixel electrode positioned at the outside of the pixel electrode. When first applying a voltage to the high-voltage electrode at the time of the electric field exposure, an alignment of the liquid crystal first begins at the outside of the pixel electrode to which a high voltage is applied. Next, when a voltage is applied to the low-voltage electrode, the region in which the texture occurs between the two electrodes is increased, which causes transmittance and control issues of the liquid crystal.

To minimize the occurrence of the texture, the liquid crystal of the first subpixel electrode 191a which is the low-voltage electrode region is first arranged, and then the liquid crystal of the second subpixel electrode 191b which is the high-voltage electrode region is aligned.

As a result, the region of the first subpixel electrode 191a which has a reduced pretilt (by applying a low voltage to the first subpixel electrode 191a) is positioned at the center of the pixel. Even though some misalignment may occur in the curved liquid crystal display, the texture (seen in the conventional pixel structure) does not occur.

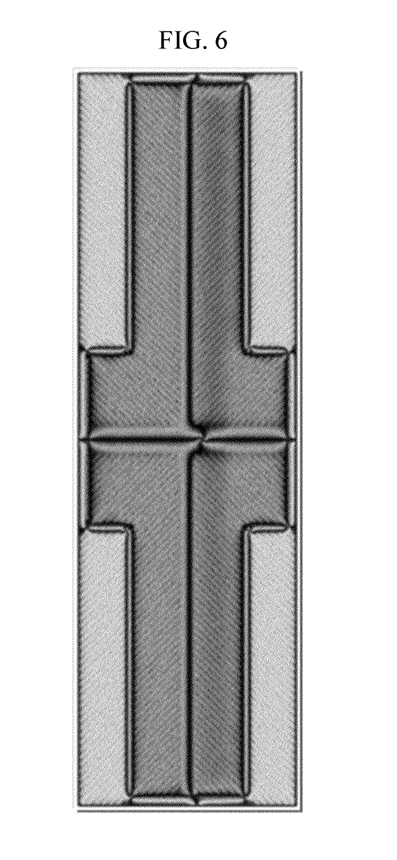

Next, the change in luminance by the misalignment depending on the pretilt angle will be described with reference to FIGS. 6, 7, 8, and 9. Specifically, FIGS. 6, 7, 8, and 9 illustrate images according to the pretilt of the electrode to which different voltages are applied.

FIGS. 6, 7, 8, and 9 illustrate a case in which the liquid crystal molecules adjacent to the second subpixel electrode 191b of the curved liquid crystal display device have a pretilt of 88.8° and the liquid crystal molecules adjacent to the first subpixel electrode 191a to which a voltage lower than that of the second subpixel electrode 191b is applied have a pretilt of 89.5°.

First, FIG. 6 illustrates a case in which a misalignment of about 30 μm causes a texture to occur. The texture causes a reduction in transmittance. The reduction in luminance may be about 3.5%.

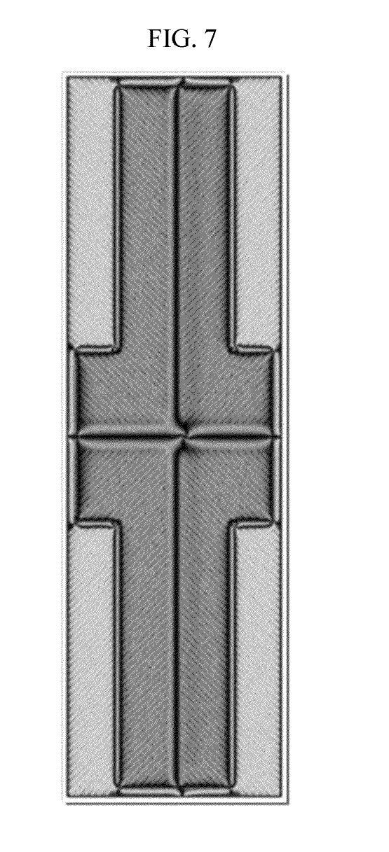

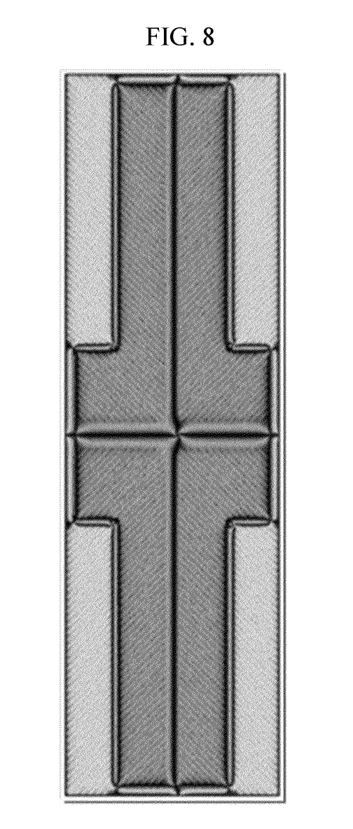

On the other hand, as illustrated in FIGS. 7 and 8, even though formation of the curved display device results in an misalignment of about 20 μm and about 10 μm, respectively, there is almost no texture. In the examples of FIGS. 7 and 8, the reduction in luminance in may be about 1.2% and about 1.1%, respectively. Therefore, the reduction in luminance may be controlled using the exemplary liquid crystal display device.

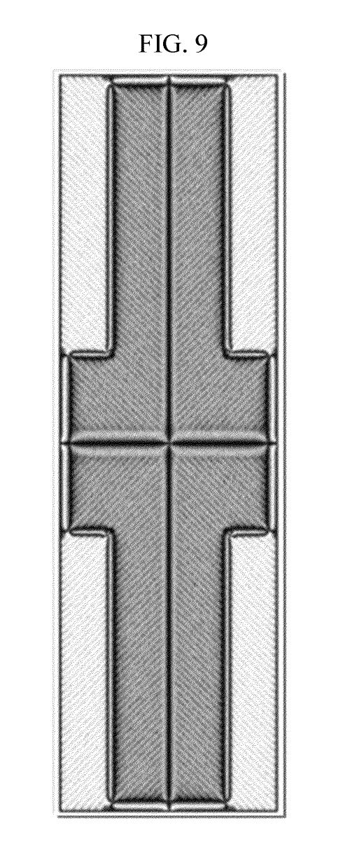

FIG. 9 illustrates a case in which there is no misalignment during the formation of the curved display device, no occurrence of texture, and no difference/reduction in luminance.

In the curved liquid crystal display device according to the exemplary embodiment, the first subpixel area to which the low voltage is applied is formed at the central portion of the pixel area. As described above, there is misalignment in the examples of FIGS. 6, 7, and 8, and no misalignment in the example of FIG. 9. However, comparing FIGS. 6, 7, and 8 with FIG. 9, it is noted that display defects (such as texture or spot commonly associated with the formation of the curved surface) does not occur even though there may be misalignment. Accordingly, the reduction in transmittance and luminance may be controlled using the exemplary curved liquid crystal display device.

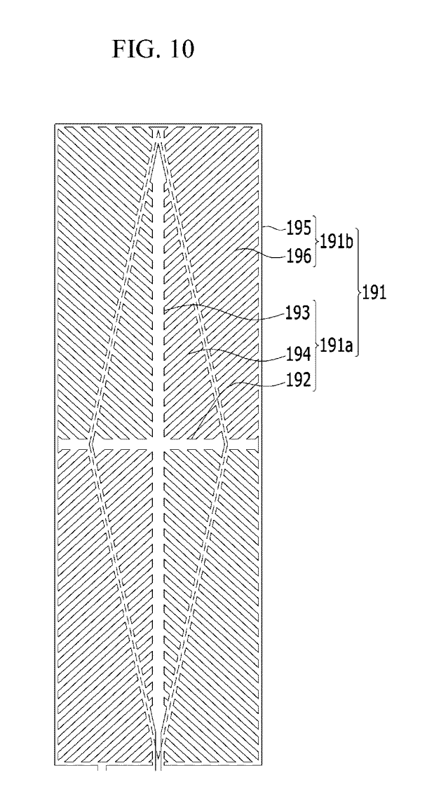

FIG. 10 is a layout view of a liquid crystal display device according to another exemplary embodiment. The liquid crystal display device of FIG. 10 is similar to the liquid crystal display device of FIGS. 1 and 2 except for the structure of the pixel electrode 191.

Referring to FIGS. 2 and 10, the liquid crystal display device includes the lower panel 100 and the upper panel 200 facing each other and the liquid crystal layer 3 interposed between the two display panels 100 and 200.

First, the lower panel 100 will be described.

The lower panel 100 includes the plurality of gate conductors disposed on the first substrate 10. The plurality of gate conductors include the gate line 121, the reference voltage line 131, and the storage electrode line 135. The gate line 121 and a step-down gate line transfer gate signals and extend in a substantially horizontal direction.

The gate line 121 includes a wide end (not illustrated) connected with a first gate electrode 124a, a second gate electrode 124b, a third gate electrode 124c, and other layers or external driving circuits. The first and second gate electrodes 124a and 124b are connected to each other.

The reference voltage line 131 may extend parallel with the gate line 121. The reference voltage line 131 includes a sustain extension 136 connected to a third drain electrode 175c, as described in further detail below.

The reference voltage line 131 includes the storage electrode line 135 enclosing a pixel area. The storage electrode line 135 may extend in a substantially vertical direction to the sustain extension 136 and the gate line. However, the structure of the storage electrode line 135 is not limited thereto and may be provided in different configurations.

The gate insulating layer 140 is formed on the gate line 121, reference voltage line 131, and storage electrode line 135.

The first semiconductor 154a, second semiconductor 154b, and third semiconductor 154c are formed on the gate insulating layer 140. The first semiconductor 154a, second semiconductor 154b, and third semiconductor 154c may be made of amorphous or crystalline silicon.

The plurality of ohmic contacts 163a, 163b, 163c, 165a and 165b are formed on the first semiconductor 154a, second semiconductor 154b, and third semiconductor 154c. In some alternative embodiments, when the semiconductors 154a, 154b, and 154c are oxide semiconductors, the ohmic contacts 163a, 165a, 163b, 165b and 163c may be omitted.

Data conductors are formed on the ohmic contacts 163a, 163ba, 163b, 163c, 165a, 165b and the gate insulating layer 140. The data conductors include data lines 171, a first drain electrode 175a, a second drain electrode 175b, a third source electrode 173a, and a third drain electrode 175c. The data lines 171 include a first source electrode 173a and a second source electrode 173b.

The bar-shaped end of the first and second drain electrodes 175a and 175b is partially enclosed with the first and second source electrodes 173a and 173b. The wide end of the second drain electrode 175b may extend and connect to the third source electrode 173c such that the second drain electrode 175b is bent in the shape of a letter ‘U’. The wide end of the third drain electrode 175c overlaps the sustain extension 136 to form a step-down capacitor, and a bar-shaped end of the third drain electrode 175c is partially enclosed with the third source electrode 173c.

The first gate electrode 124a, first source electrode 173a, and first drain electrode 175a, together with the first semiconductor 154a, collectively constitute a first thin film transistor Qa. A channel of the first thin film transistor Qa is formed at the semiconductor part 154a between the first source electrode 173a and the first drain electrode 175a. Similarly, the second gate electrode 124b, second source electrode 173b, and second drain electrode 175b, together with the second semiconductor 154b, collectively constitute a second thin film transistor Qb. A channel of the second thin film transistor Qb is formed at the semiconductor part 154b between the second source electrode 173b and the second drain electrode 175b. Likewise, the third gate electrode 124c, third source electrode 173c, and third drain electrode 175c, together with the third semiconductor 154c, collectively constitute a third thin film transistor Qc. A channel of the third thin film transistor Qc is formed at the semiconductor part 154c between the third source electrode 173c and the third drain electrode 175c.

The passivation layer 180 is formed on the data conductors 171, 173a, 173b, 173c, 175a, 175b, and 175c and the exposed semiconductor parts 154a, 154b, and 154c. The passivation layer 180 may be made of inorganic insulating materials such as silicon nitride and silicon oxide.

The color filter 230 is disposed on the passivation layer 180.

The light blocking member (not illustrated) may be disposed over the color filter 230. The light blocking member 220 is referred to as a black matrix and prevents light leakage.

The capping layer 80 is disposed on the color filter 230. The capping layer 80 prevents the color filter 230 from lifting off. The capping layer 80 also prevents contamination of the liquid crystal layer 3 due to organic materials (such as a solvent introduced from the color filter). Accordingly, the capping layer 80 can prevent defects such as afterimage which may occur when the display screen is being driven.

The pixel electrode 191 is formed on the capping layer 80. The pixel electrode 191 includes the first subpixel electrode 191a and the second subpixel electrode 191b are spaced apart from each other.

The pixel electrode 191 may be made of transparent conductive materials (such as ITO and IZO) or reflective metals (such as aluminum, silver, chromium, or an alloy thereof).

The pixel electrode 191 including the first subpixel electrode 191a and the second subpixel electrode 191b may have a quadrangle shape. The pixel electrode 191 further includes a connection part (dotted line in FIG. 10) formed between the first subpixel electrode 191a and the second subpixel electrode 191b. The connection part can improve the control efficiency and transmittance of the liquid crystal.

Referring to FIG. 10, the first subpixel electrode 191a includes a plurality of fine branch parts extending from cruciform stem parts 192 and 193 toward an outside portion of the pixel area. Specifically, the first subpixel electrode 191a has a rhombus shape in which the fine branch parts extend from the cruciform stem part and the second subpixel electrode 191b, such that four triangular shapes are positioned at the four respective corners of the pixel electrode 191.

Each of the first subpixel electrode 191a and second subpixel electrode 191b may be divided into four domain regions. The domain region refers to an area comprising liquid crystal molecules having inclined directors. Specifically, the liquid crystal molecules are clustered in a specific direction by an electric field formed between the pixel electrode 191 and a common electrode. Each domain of the first subpixel electrode 191a and second subpixel electrode 191b has a triangular shape. The areas of the domains of the first subpixel electrode 191a and second subpixel electrode 191b may be same or different. Furthermore, the boundaries between the four domains may be bent depending on the shape/configuration of the first subpixel electrode 191a and the second pixel electrode 191b.

The first subpixel electrode 191a includes the cruciform stem parts 192 and 193 dividing the pixel area into four domain regions. The cruciform stem parts 192 and 193 include the horizontal stem part 192 and the vertical stem part 193. The first subpixel electrode 191a includes a plurality of first branch electrodes 194 extending from the cruciform stem parts 192 and 193 and arranged in a constant direction within each domain. The interval spacing between the first branch electrodes 194 may be constant.

The first branch electrodes 194 extend in four different directions. Specifically, the first branch electrodes 194 include a plurality of first fine branch parts extending obliquely in an upward left direction from the cruciform stem parts 192 and 193, a plurality of second fine branch parts extending obliquely in an upward right direction from the cruciform stem parts 192 and 193, a plurality of third fine branch parts extending obliquely in a downward left direction from the cruciform stem parts 192 and 193, and a plurality of fourth fine branch parts extending obliquely in a downward right direction from the cruciform stem parts 192 and 193. The first fine branch parts may form an angle of about 45° to the fourth fine branch parts and the horizontal stem part 192.

The second subpixel electrode 191b is divided into four domain regions by the first subpixel electrode 191a. Specifically, the second subpixel electrode 191b is disposed at four corners of the pixel electrode. The second subpixel electrode 191b may include an outer stem part 195 enclosing edges of the pixel area and a plurality of second branch electrodes 196 extending from the outer stem part 195.

According to another exemplary embodiment, the second subpixel electrode 191b may include the first connection part disposed at an edge of the pixel electrode 191 whereby the first connection part is adjacent to the first subpixel electrode 191a. The second subpixel electrode 191b further includes a plurality of second branch electrodes 196 extending from the first connection part.

The second branch electrodes 196 are arranged in a constant direction within each domain and extend in four different directions. Specifically, the second branch electrodes 196 include a plurality of fifth fine branch parts extending obliquely in an upward left direction from the cruciform stem parts 192 and 193, a plurality of sixth fine branch parts extending obliquely in an upward right direction from the cruciform stem parts 192 and 193, a plurality of seventh fine branch parts extending obliquely in a downward left direction from the cruciform stem parts 192 and 193, and a plurality of eighth fine branch parts extending obliquely in a downward right direction from the cruciform stem parts 192 and 193. The fifth fine branch parts may form an angle of about 45° to the eighth fine branch parts and the horizontal stem part 192.

The first fine branch parts, second fine branch parts, third fine branch parts, and fourth fine branch parts formed in each domain of the first subpixel electrodes 191a extend in the same direction as the respective fifth fine branch parts, sixth fine branch parts, seventh fine branch parts, and eighth fine branch parts formed in each domain of the second subpixel electrode 191b. Therefore, the liquid crystal molecules that are inclined in the same direction are formed within the domain region including the fine branch parts that extend in the same direction.

Furthermore, the horizontal stem part 192 or the vertical stem part 193 of the first subpixel electrode 191a may be disposed between the second branch electrodes 196 of the second subpixel electrode 191b. That is, the second subpixel electrodes 191b are spaced apart from each other by the first subpixel electrode 191a, but the second branch electrodes 196 of the second subpixel electrode 191b may extend from the horizontal stem part 192 or the vertical stem part 193 such that the second branch electrodes 196 are adjacent to each other. In the above embodiment, an electric field is generated between a portion of the horizontal stem part 192 or the vertical stem part 193 of the first subpixel electrodes 191a that are adjacent to each other and the second branch electrodes 196 of the second subpixel electrode 191b. Therefore, the liquid crystal molecules that are disposed around the horizontal stem part 192 or the vertical stem part 193 of the first subpixel electrode 191a are inclined in a direction substantially parallel with a direction in which the second branch electrodes 196 of the second subpixel electrode 191b extend. As a result, deterioration of transmittance which may occur around a portion of the horizontal stem part 192 or the vertical stem part 193 of the first subpixel electrode can be prevented.

The first subpixel electrode 191a having the reduced pretilt is disposed at the center of the pixel area. Thus, even though some misalignment due to the warpage of the substrate may occur during the formation of the curved liquid crystal display device, texture (or spots) does not occur.

The first subpixel electrode 191a is physically and electrically connected to the second drain electrode 175b through the second contact hole 185b, and the second subpixel electrode 191b is physically and electrically connected to the first drain electrode 175a through the first contact hole 185a. An electric field is generated by applying the data voltage to the first subpixel electrode 191a and the second subpixel electrode 191b, along with a common electrode 270. The electric field determines an orientation of liquid crystal molecules of the liquid crystal layer 3 between the subpixel electrodes and the common electrode. The luminance of light passing through the liquid crystal layer 3 changes according to the orientation of the liquid crystal molecules.

Next, the upper panel 200 will be described.

The light blocking member 220 and a common electrode 270 are formed on the second substrate 210. The second substrate 210 may be made of transparent glass, plastic, or the like.

The inner sides of the display panels 100 and 200 are provided with alignment layers (not illustrated). The alignment layers may include a vertical alignment layer.

The liquid crystal layer 3 has a negative dielectric anisotropy. Accordingly, the liquid crystal molecules of the liquid crystal layer 3 are aligned such that the major axes of the liquid crystal molecules are perpendicular to the surfaces of the two display panels 100 and 200 in the absence of an electric field. Therefore, when an electric field is absent, incident light does not pass through the crossed polarizers but is instead blocked.

At least one of the liquid crystal layer 3 and an alignment layer may include a photoreactive material, for example, a reactive mesogen.

While the inventive concept has been described in connection with what is presently considered to be exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A liquid crystal display device, comprising:
a first substrate;
a pixel electrode formed on the first substrate, wherein the pixel electrode includes a first subpixel electrode and a second subpixel electrode disposed in a pixel area and spaced apart from each other, and wherein the second subpixel electrode is disposed at four corners of the pixel area;
a second substrate facing the first substrate;
a common electrode formed on the second substrate; and
a liquid crystal layer disposed between the first substrate and the second substrate,
wherein a first voltage is applied to the first subpixel electrode and a second voltage is applied to the second subpixel electrode, and
wherein the first voltage is different from the second voltage.

2. The liquid crystal display device of claim 1, wherein the liquid crystal display device is a curved type liquid crystal display.

3. The liquid crystal display device of claim 2, wherein the first voltage is less than the second voltage.

4. The liquid crystal display device of claim 3, wherein the first subpixel electrode includes a plurality of first branch electrodes and the second subpixel electrode includes a plurality of second branch electrodes.

5. The liquid crystal display device of claim 4, wherein the first subpixel electrode has a dodecagonal polygon shape, and the second subpixel electrode has a shape including a cluster of four quadrangles.

6. The liquid crystal display device of claim 4, wherein the first subpixel electrode has a rhombus shape, and the second subpixel electrode has a shape including a cluster of four triangles.

7. The liquid crystal display device of claim 5, wherein the first subpixel electrode further comprises a cruciform stem part including a horizontal stem part and a vertical stem part, and
wherein the plurality of first branch electrodes extend in four different directions from the cruciform stem.

8. The liquid crystal display device of claim 7, wherein the second subpixel electrode further comprises an outer stem part disposed positioned outside the pixel area, and
wherein the plurality of second branch electrodes extend in four different directions from the outer stem part toward the first subpixel electrode.

9. The liquid crystal display device of claim 6, wherein the first subpixel electrode further comprises a cruciform stem part including a horizontal stem part and a vertical stem part, and
wherein the plurality of first branch electrodes extend in four different directions from the cruciform stem.

10. The liquid crystal display device of claim 9, wherein the second subpixel electrode further comprises an outer stem part disposed outside the pixel area, and
wherein the plurality of second branch electrodes extend in four different directions from the outer stem part toward the first subpixel electrode.
